(19) United States
(12) Patent Application Publication
(10) Pub. No.: US 2015/0193133 A1
(43) Pub. Date: Jul. 9, 2015

(54) DISPLAY CONTROL APPARATUS AND DISPLAY CONTROL METHOD

(71) Applicant: CANON KABUSHIKI KAISHA, Tokyo (JP)

(72) Inventor: Tomoyuki Ohno, Zama-shi (JP)

(21) Appl. No.: 14/570,249

(22) Filed: Dec. 15, 2014

(30) Foreign Application Priority Data
Jan. 9, 2014 (JP) 2014-002661

(51) Int. Cl. G06F 3/0484

(52) U.S. Cl. CPC G06F 3/04847; G06F 3/04842

(57) ABSTRACT

A display control apparatus includes a display control, a selection unit, and a control unit. The display control unit is configured to superimpose and display a second display item on a first display item on a display unit. The selection unit is configured to select a display item displayed on the display unit. The control unit is configured to control not to accept a selection operation of the second display item within a predetermined time after the second display item starts to be displayed.

### BACKGROUND OF THE INVENTION

1. Field of the Invention

The present invention relates to a display control apparatus and a display control method.

2. Description of the Related Art

Market needs for thin display devices (for example, a display and tablet terminal) such as a liquid crystal panel and organic EL panel have advanced and diversified. Many thin display devices have buttons for operating a display and an OSD (On Screen Display) function, and can adjust the image quality, brightness, contrast, color temperature, and the like of an image to be displayed. The number of users of tablet terminals using a liquid crystal panel or organic EL panel is rapidly increasing due to their convenience. A tablet terminal includes a touch panel, and the user can thus intuitively operate the tablet terminal by touching the touch panel by a finger or stylus.

The market need for operating a thin display device by a touch panel, similarly to the tablet terminal, is growing. To cope with this need, the OS of a personal computer (PC) supports a touch panel as a standard. A display connected to the PC includes a touch panel, and the user can operate the PC and executes the OSD function of the display by touching the touch panel of the display.

According to Japanese Patent Laid-Open No. 2009-176227, for example, it is possible to switch a touch panel operation target between a PC and a display by providing an operation target switching button in the display.

Furthermore, Japanese Patent Laid-Open No. 2009-080683 discloses a technique of deciding the setting region of a touch panel based on user designation, and switching the decided region between an enable state and a disable state. According to Japanese Patent Laid-Open No. 2009-080683, the user needs to designate a region where a touch operation is disabled.

On the other hand, a device which can be operated without requiring the user to switch the operation target by automatically determining an operation for a display or PC is also desired.

The OSD of a display is displayed as a menu screen for setting the image quality of a display panel and the like. This menu screen starts to be displayed in response to a user operation, and is automatically cleared if no operation is performed for a given time after display.

If a display item such as a menu screen is displayed or cleared at a timing unintended by the user as described above, when the user performs some operation, the operation of a display item such as another icon or button unintended by the user may be executed.

For example, if the user operates a menu screen 601 shown in FIG. 6B when the menu screen is automatically cleared, the user unwantedly taps an icon on a home screen 600 shown in FIG. 6A, thereby activating an application unintended by the user.

If a mail reception notification 701 shown in FIG. 7B is displayed when mail is received while a Web page 700 shown in FIG. 7A is displayed, and the user operates the Web page at the same time, the user unintentionally taps the button of the mail reception notification 701.

If the user attempts to operate the mail reception notification 701 immediately after the mail reception notification 701 is automatically cleared since no operation is performed for a given time after display of the mail reception notification 701 shown in FIG. 7B, the user unintentionally taps the Web page 700 shown in FIG. 7A.

Assume that a decrease in remaining battery capacity is detected while a home screen 800 shown in FIG. 8A is displayed. In this case, if the user operates the home screen simultaneously with display of a warning screen 801 shown in FIG. 8B, the user unintentionally taps a button on the warning screen 801.

If the warning screen 801 shown in FIG. 8B is automatically cleared, and the user operates the warning screen 801 at the same time, the user unintentionally taps an icon on the home screen 800 shown in FIG. 8A.

### SUMMARY OF THE INVENTION

The present invention has been made in consideration of the aforementioned problems, and realizes a technique capable of suppressing execution of an operation unintended by the user.

In order to solve the aforementioned problems, the present invention provides a display control apparatus comprising: a display control unit configured to superimpose and display a second display item on a first display item on a display unit; a selection unit configured to select a display item displayed on the display unit; and a control unit configured to control not to accept a selection operation of the second display item within a predetermined time after the second display item starts to be displayed.

In order to solve the aforementioned problems, the present invention provides a display control apparatus comprising: a display control unit configured to superimpose and display a second display item on a first display item on a display unit; a selection unit configured to select a display item displayed on the display unit; and a control unit configured to control not to accept a selection operation of the first display item within a predetermined time after the second display item which has been superimposed and displayed on the first display item is cleared.

In order to solve the aforementioned problems, the present invention provides a display control apparatus comprising: a display control unit configured to control display contents on a display device; and an acceptance unit configured to accept an operation of operating a displayed display item, wherein the display control unit controls not to superimpose and display a second display item on a first display item displayed on the display device during a period in which an operation of the first display item is accepted.

In order to solve the aforementioned problems, the present invention provides a display control apparatus comprising: a display control unit configured to control display contents on a display device; and an acceptance unit configured to accept an operation of operating a displayed display item, wherein the display control unit controls not to clear a display item displayed on the display device during a period in which an operation of the display item is accepted.

In order to solve the aforementioned problems, the present invention provides a display control method comprising: a display control step of superimposing and displaying a second display item on a first display item on a display unit; a selection step of selecting a display item displayed on the display unit; and a control step of controlling not to accept a selection operation of the second display item within a predetermined time after the second display item starts to be displayed.

In order to solve the aforementioned problems, the present invention provides a display control method comprising: a display control step of superimposing and displaying a second display item on a first display item on a display unit; a selection step of selecting a display item displayed on the display unit; and a control step of controlling not to accept a selection operation of the first display item within a predetermined time after the second display item which has been superimposed and displayed on the first display item is cleared.

In order to solve the aforementioned problems, the present invention provides a display control method comprising: a display control step of controlling display contents on a display device; and an acceptance step of accepting an operation of operating a displayed display item, wherein in the display control step, it is controlled not to superimpose and display a second display item on a first display item displayed on the display device during a period in which an operation of the first display item is accepted.

In order to solve the aforementioned problems, the present invention provides a display control method comprising: a display control step of controlling display contents on a display device; and an acceptance step of accepting an operation of operating a displayed display item, wherein in the display control step, it is controlled not to clear a display item displayed on the display device during a period in which an operation of the display item is accepted.

According to the present invention, it is possible to suppress execution of an operation unintended by the user by temporarily disabling a touch operation at the timing of displaying/clearing a screen without any user operation.

Further features of the present invention will become apparent from the following description of exemplary embodiments (with reference to the attached drawings).

### BRIEF DESCRIPTION OF THE DRAWINGS

FIG. 1 is a block diagram showing an apparatus configuration according to an embodiment;

FIG. 2 is a flowchart illustrating display control processing according to the first embodiment;

FIG. 3 is a flowchart illustrating display control processing according to the second embodiment;

FIG. 4 is a block diagram showing a device configuration according to the third embodiment;

FIG. 5 is a flowchart illustrating display control processing according to the third embodiment;

FIGS. 6A and 6B are views exemplifying transition of a display screen according to the embodiment;

FIGS. 7A and 7B are views exemplifying transition of a display screen according to the embodiment;

FIGS. 8A and 8B are views exemplifying transition of a display screen according to the embodiment; and

FIGS. 9A and 9B are views exemplifying transition of a display screen according to the embodiment.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

### First Embodiment

A display control apparatus of the present invention will be described below according to an embodiment applied to a tablet terminal which can be operated through a touch panel. Note that the present invention is widely applicable to an image capturing apparatus such as a digital camera and a mobile electronic device such as a smartphone.

<Apparatus Configuration>

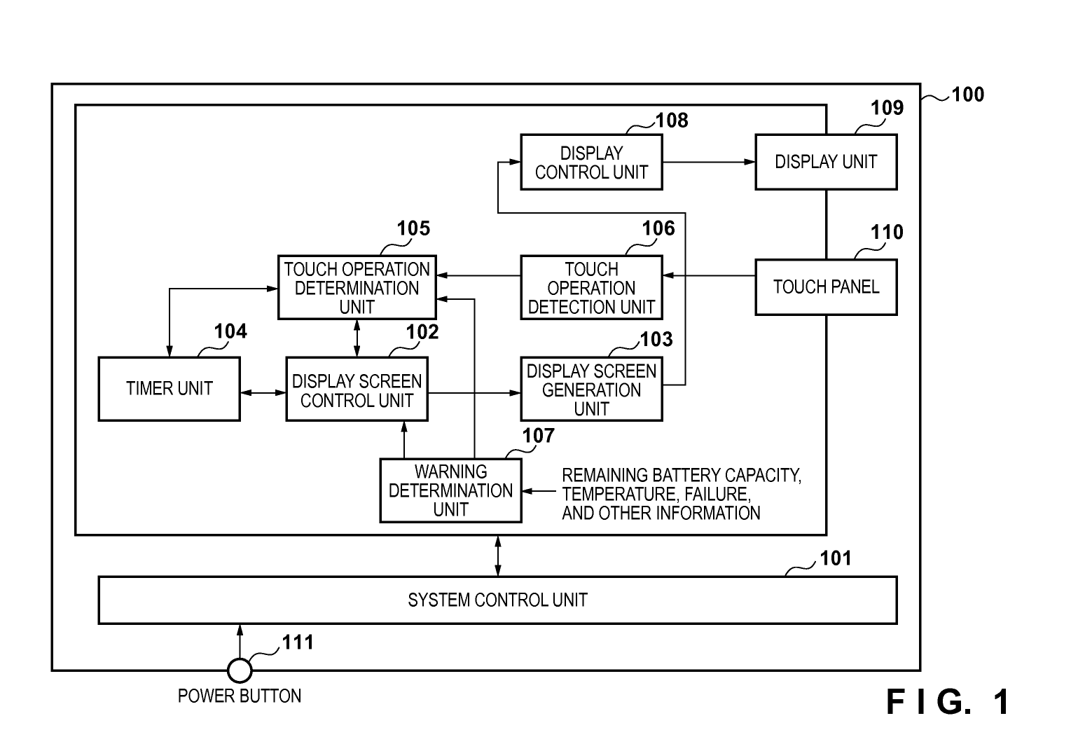

The configuration and function of a tablet terminal 100 according to the embodiment will be schematically described with reference to FIG. 1.

Referring to FIG. 1, a system control unit 101 includes a CPU, a ROM, and a RAM. The CPU loads a program stored in the ROM to the work area of the RAM, and executes the program, thereby controlling the operation of the overall apparatus.

According to a control command of a display control unit 108, a display screen control unit 102 displays, on a display unit 109, screen data (a home screen, application screen, or OSD screen) generated by a display screen generation unit 103.

According to a control command of the display control unit 108, the display screen generation unit 103 generates screen data to be displayed on the display unit 109.

A timer unit 104 measures times to be used for various control operations, the time of a calendar clock, and the display duration of a warning screen or menu screen (to be described later).

A touch operation determination unit 105 determines an operation performed for a touch panel 110 based on a detection result from a touch operation detection unit 106.

The touch operation detection unit 106 detects a touch position and a touch time for the touch panel 110, and outputs a detection result to the touch operation determination unit 105.

A warning determination unit 107 determines whether a factor has occurred in the tablet terminal 100, such as a decrease in remaining battery capacity, an abnormal increase in temperature, or a failure of a part which may influence the function and performance of the tablet terminal 100.

The display control unit 108 converts display contents such as screen data generated by the display screen generation unit 103 into data to be displayed at a timing appropriate for the display resolution, display color count, and refresh rate of the display unit 109, and outputs the converted data to the display unit 109.

The display unit 109 is formed from a liquid crystal panel, an organic EL panel, or the like, and displays the screen data obtained from the display control unit 108.

The display unit 109 is formed from a liquid crystal panel, an organic EL panel, or the like which displays an application screen, an OSD screen, or the like.

The touch panel 110 can detect a touch on the display unit 109. The touch panel 110 and display unit 109 can be integrally formed, and can constitute a GUI which looks as if the user can directly operate a screen displayed on the display unit 109.

A power button 111 outputs an operation signal for switching ON/OFF of the power supply of the tablet terminal 100 to the system control unit 101.

Touch operations which can be determined by the touch operation determination unit 105 will be exemplified below.

Tap: lightly tapping a screen by a finger or stylus (corresponding to click as a mouse operation of a PC)

Drag: sliding a finger or stylus to a desired position while the finger or stylus is kept touched on the screen

Flick: flicking a finger or stylus in a desired moving direction while the finger or stylus is kept touched on the screen

Pinch: opening or closing (pinching) while two fingers are kept touched on the screen

Double tap: lightly tapping the screen twice without moving the position of a finger (corresponding to double click as a mouse operation of a PC)

Long touch: continuously touching the screen for a given time

<Basic Operation>

The basic operation of the tablet terminal 100 will now be described.

The tablet terminal 100 is activated when the user turns on the power button 111.

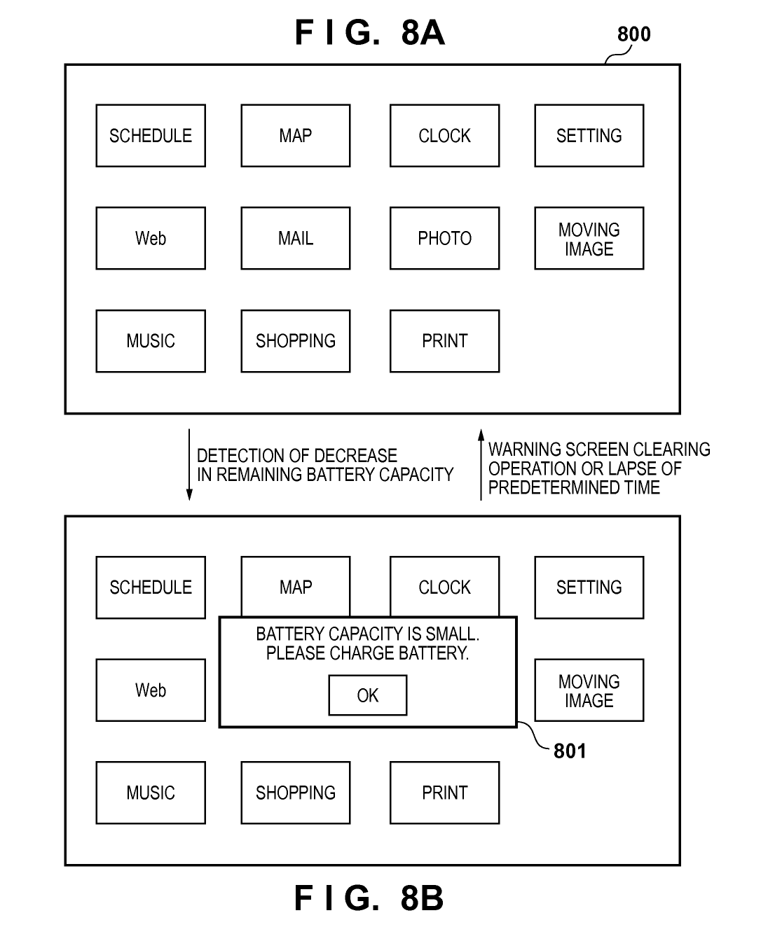

When the system control unit 101 detects that the power button 111 is turned on, it outputs, for example, a request to display a home screen 800 shown in FIG. 8A to the display screen control unit 102.

Based on the display request received from the display screen control unit 102, the display screen generation unit 103 generates screen data to be displayed on the display unit 109.

The display control unit 108 converts the screen data generated by the display screen generation unit 103 into data to be displayed at a timing appropriate for the display resolution, display color count, and refresh rate of the display unit 109, and outputs the converted data to the display unit 109.

The display unit 109 displays the screen data received from the display control unit 108 on a display panel.

<Normal Screen Display Example>

Transition of the display screen of the tablet terminal 100 according to this embodiment will be explained.

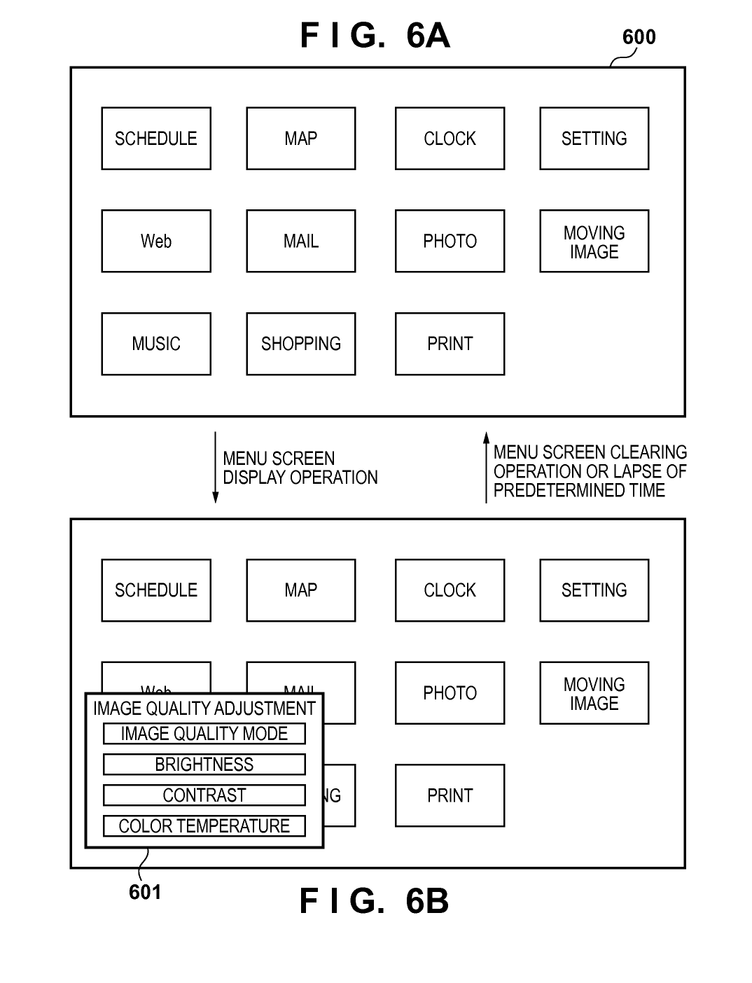

FIG. 6A shows a home screen 600 on which icons corresponding to applications to be executed by the user on the tablet terminal 100 are displayed as display items. FIG. 6B shows a state in which a menu screen 601 for operating the display is displayed on the home screen.

A plurality of icons are displayed on the home screen 600. When the user taps one of the icons, he/she can activate application software (to be referred to as an application hereinafter) to be executed on the tablet terminal 100. If, for example, the user taps a “mail” icon, an application for transmitting/receiving email is activated. Similarly, if the user taps another icon, an application corresponding to the icon is activated. If the user performs a menu display operation while the home screen 600 shown in FIG. 6A is displayed, the state transits to a state in which the menu screen 601 shown in FIG. 6B is displayed. If no operation is detected for a given time or the user performs an OSD clearing operation in the OSD display state shown in FIG. 6B, the menu screen 601 is cleared to return to the home screen display state shown in FIG. 6A.

The tablet terminal 100 can operate various applications such as a mail application, Web browser application, and photo browsing application, and simultaneously operate the applications. For example, the mail application and Web browser application are operated at the same time, and a notification indicating reception of mail can be displayed to the user while the Web browser application displays a Web page.

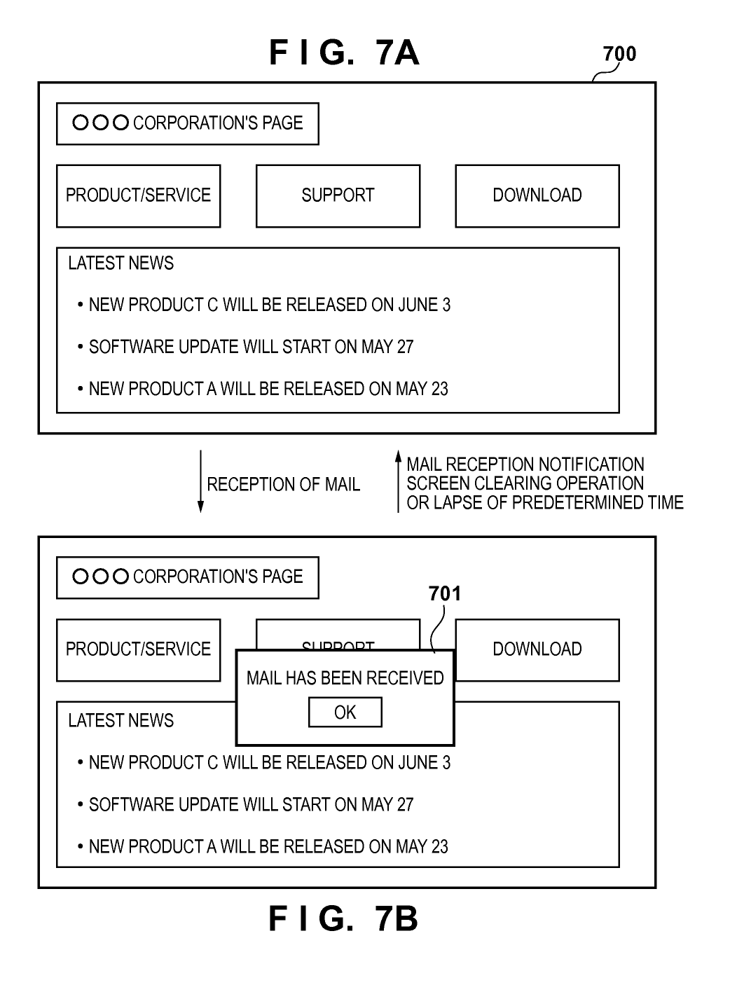

FIG. 7A shows a state in which a Web page 700 is displayed as a display item on the tablet terminal 100. FIG. 7B shows a state in which a dialog of a mail reception notification 701 for notifying the user of reception of mail is displayed as a display item while the Web page is displayed.

When reception of mail is detected while the Web page 700 shown in FIG. 7A is displayed, the state transits to a state in which the mail reception notification 701 shown in FIG. 7B is displayed. If an “OK” button of the mail reception notification 701 is tapped or no operation is detected for a given time in the mail reception notification state shown in FIG. 7B, the mail reception notification 701 is cleared to return to the Web page display state shown in FIG. 7A.

In the tablet terminal 100, for example, if a decrease in remaining battery capacity or an abnormal increase in temperature is detected as an event which may influence the function and performance of the tablet terminal 100, a warning screen is displayed to notify the user of the event.

FIG. 8A shows the home screen 800. FIG. 8B shows a state in which a dialog of a warning screen 801 is displayed as a display item on the home screen. When it is detected that the remaining battery capacity decreases to be lower than a predetermined value while the home screen shown in FIG. 8A is displayed, the state transits to a state in which the warning screen 801 for notifying the user of the decrease in the remaining battery capacity is displayed, as shown in FIG. 8B. If an “OK” button on the warning screen 801 is tapped or no operation is detected for a given time in the warning screen display state shown in FIG. 8B, the warning screen 801 is cleared to return to the home screen display state shown in FIG. 8A.

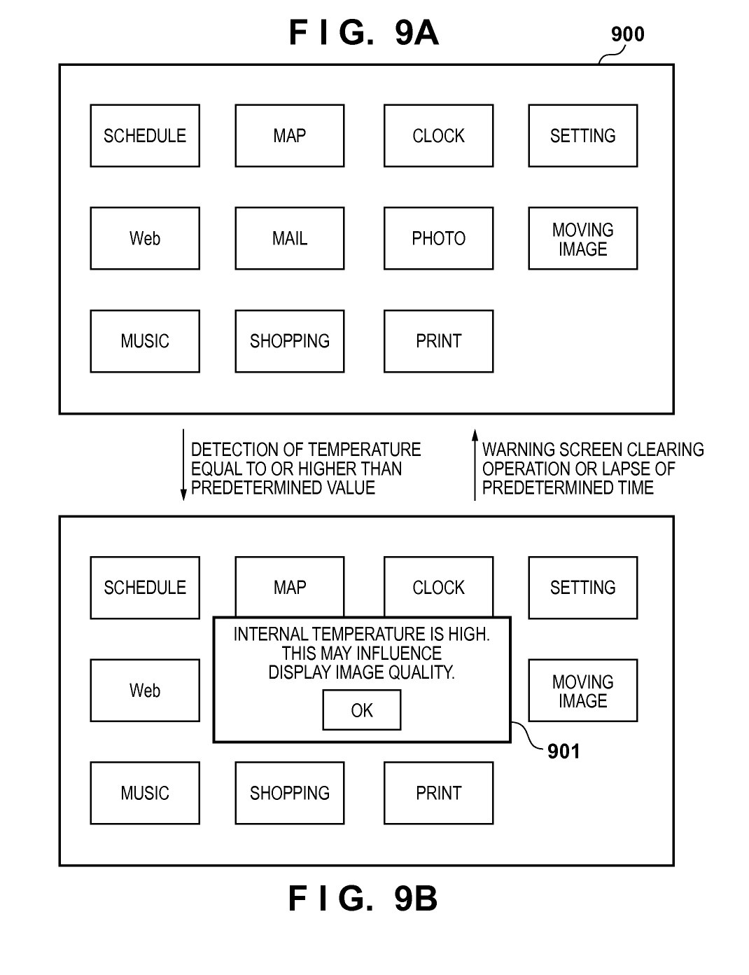

FIG. 9A shows a home screen 900. FIG. 9B shows a state in which a dialog of a warning screen 901 is displayed as a display item on the home screen. If, for example, it is detected that the temperature of the device increases to be higher than a predetermined value while the home screen shown in FIG. 9A is displayed, the state transits to a state in which the warning screen 901 for notifying the user of a decrease in image quality caused by the increase in temperature of the device is displayed, as shown in FIG. 9B. If an “OK” button on the warning screen 901 is tapped or no operation is detected for a given time in the warning screen display state shown in FIG. 9B, the warning screen 901 is cleared to return to the home screen display state shown in FIG. 9A.

<Warning Screen Display Processing>

Processing of displaying/clearing the warning screen when the warning determination unit 107 determines whether an event which may influence the function and performance of the tablet terminal 100 has occurred will be described by exemplifying a case in which a decrease in remaining battery capacity is detected.

Processing of displaying the warning screen for notifying the user of a decrease in remaining battery capacity will be explained first.

The tablet terminal 100 incorporates a battery (not shown).

The warning determination unit 107 acquires information about the battery, such as the remaining battery capacity and temperature, and monitors an increase/decrease in temperature and remaining battery capacity.

When the remaining battery capacity becomes equal to or smaller than a predetermined value, the warning determination unit 107 displays a “remaining battery capacity warning screen” on the display unit 109 in cooperation with the display screen control unit 102, display screen generation unit 103, and display control unit 108.

While displaying the warning screen, the display screen control unit 102 starts measuring the display duration of the warning screen in cooperation with the timer unit 104.

FIG. 8B shows the state in which the warning screen 801 for notifying the user of a decrease in remaining battery capacity is displayed while the home screen is displayed.

Processing of clearing the warning screen for notifying the user of a decrease in remaining battery capacity will be described next.

In this embodiment, there are two factors which clear the warning screen. One factor is that the user taps the “OK” button on the warning screen. The other factor is that the warning screen is continuously displayed for the given time (for example, 2 sec). When the touch operation determination unit 105 determines that the user has tapped the “OK” button on the warning screen, it requests the display screen control unit 102 to clear the warning screen. The display screen control unit 102 clears the remaining battery capacity warning screen displayed on the display unit 109 in cooperation with the display screen generation unit 103 and display control unit 108. The timer unit 104 measures the display duration of the warning screen. When it is determined that the warning screen has been continuously displayed for the given time, the display screen control unit 102 clears the warning screen in cooperation with the timer unit 104.

<Display Control Processing>

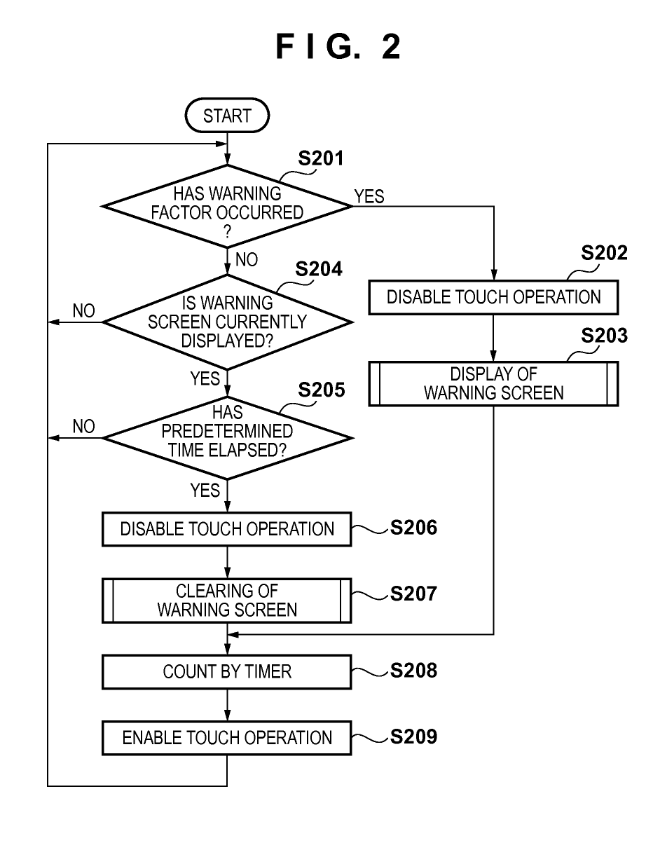

Display control processing according to the first embodiment of the present invention will be described with reference to FIG. 2.

In this embodiment, if the remaining battery capacity warning screen is displayed while the user operates the desktop of the tablet terminal 100, no touch operation is accepted within a predetermined time. More specifically, execution of an operation unintended by the user is suppressed by disabling a touch operation by the user for a given time after the warning screen starts to be displayed and for a given time after the warning screen is cleared.

Note that processing shown in FIG. 2 starts when the power button 111 of the tablet terminal 100 is turned on, and is implemented when the system control unit 101 loads a program stored in the ROM to the work area of the RAM, and executes the program.

In step S201, the warning determination unit 107 acquires information about the remaining battery capacity, and determines whether a factor which causes the warning screen for the remaining battery capacity to be displayed has occurred. If the remaining battery capacity is equal to or smaller than the predetermined value, the warning determination unit 107 determines that a warning factor has occurred, and requests the touch operation determination unit 105 to disable a touch operation, and the process advances to step S202. Alternatively, if the remaining battery capacity exceeds the predetermined value, the warning determination unit 107 determines that no warning factor has occurred, and the process advances to step S204.

In step S202, the touch operation determination unit 105 disables a touch operation based on the touch operation disabling request from the warning determination unit 107. As a method of disabling a touch operation, the touch operation determination unit 105 disables the information obtained from the touch operation detection unit 106 not to accept a touch operation by the user.

In step S203, the warning determination unit 107 requests the display screen control unit 102 to display the “remaining battery capacity warning screen” as a warning screen display request. The display screen control unit 102 displays the “remaining battery capacity warning screen” on the display unit 109 via the display screen generation unit 103 and display control unit 108, and the process advances to step S208.

In step S204, the display screen control unit 102 determines whether the warning screen is currently displayed. If it is determined that the warning screen is currently displayed, the process advances to step S205; otherwise, the process returns to step S201.

In step S205, the display screen control unit 102 determines whether the display duration of the warning screen, which is measured by the timer unit 104, is equal to or longer than a predetermined time and the timing of clearing the warning screen has come. If it is determined that the clearing timing has come, the display screen control unit 102 requests the touch operation determination unit 105 to disable a touch operation, and the process advances to step S206; otherwise, the process returns to step S201.

In step S206, the touch operation determination unit 105 disables a touch operation based on the touch operation disabling request from the display screen control unit 102, similarly to step S202.

In step S207, the display screen control unit 102 clears the currently displayed “remaining battery capacity warning screen”.

In step S208, the touch operation determination unit 105 causes the timer unit 104 to measure a time after the warning screen starts to be displayed (S203) and a time after the warning screen is cleared, and maintains the touch operation disabled state until a predetermined time (for example, 2 sec) elapses.

In step S209, the touch operation determination unit 105 enables a touch operation after the predetermined time elapses. As a method of enabling a touch operation, the touch operation determination unit 105 enables the information obtained from the touch operation detection unit 106 to accept a touch operation by the user.

As described above, according to this embodiment, it is possible to suppress execution of an operation unintended by the user by disabling a touch operation by the user for a given time after the warning screen starts to be displayed and a given time after the warning screen is cleared.

### Second Embodiment

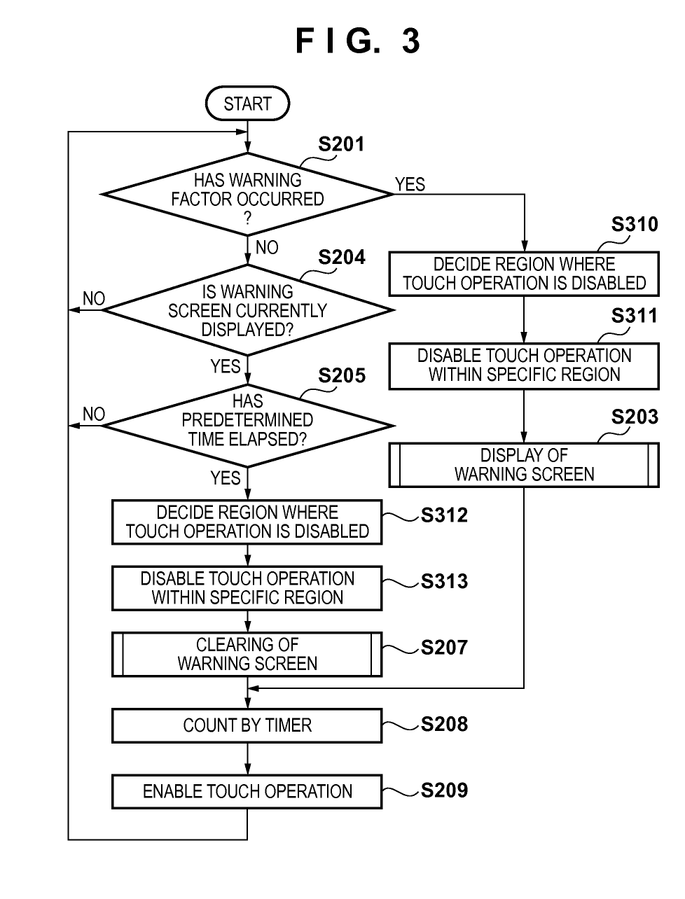

Display control processing according to the second embodiment of the present invention will be described with reference to FIG. 3.

In this embodiment, with respect to the processing shown in FIG. 2, a touch operation within a predetermined region is disabled based on the size of a warning screen.

Therefore, the same reference symbols as those shown in FIG. 2 denote the same steps and a description thereof will be omitted. Different processes will be mainly described. An apparatus configuration is the same as that shown in FIG. 1.

In step S310, upon accepting a touch operation disabling request from a warning determination unit 107, a touch operation determination unit 105 decides a region where a touch operation is disabled (touch operation region decision processing). Note that the touch operation determination unit 105 acquires, from a display screen control unit 102, information about the size and display position of a warning screen to be displayed, and calculates, based on the information, the region where a touch operation is disabled. In this embodiment, a region having the same size and display position as those of the warning screen is decided as a region where a touch operation is disabled.

In step S311, the touch operation determination unit 105 disables a touch operation within the region decided in step S310. A method of disabling a touch operation is the same as that in step S202 or S206 of FIG. 2.

After that, the touch operation disabled state is maintained for a given time after the warning screen starts to be displayed.

In steps S312 and S313, a touch operation within the predetermined region is disabled, and then the touch operation disabled state is maintained for the given time after the warning screen is cleared, similarly to steps S310 and S311.

According to this embodiment, similarly to the first embodiment, it is possible to suppress execution of an operation unintended by the user by disabling a touch operation by the user within the predetermined region for the given time after the warning screen starts to be displayed and for the given time after the warning screen is cleared.

### Third Embodiment

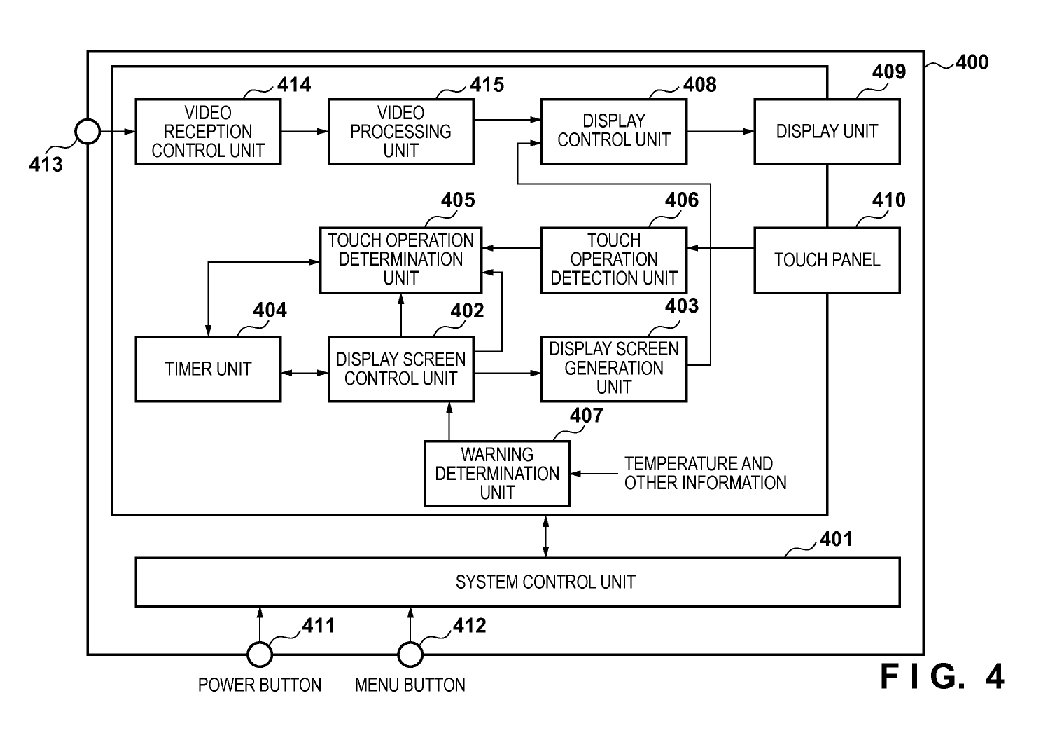

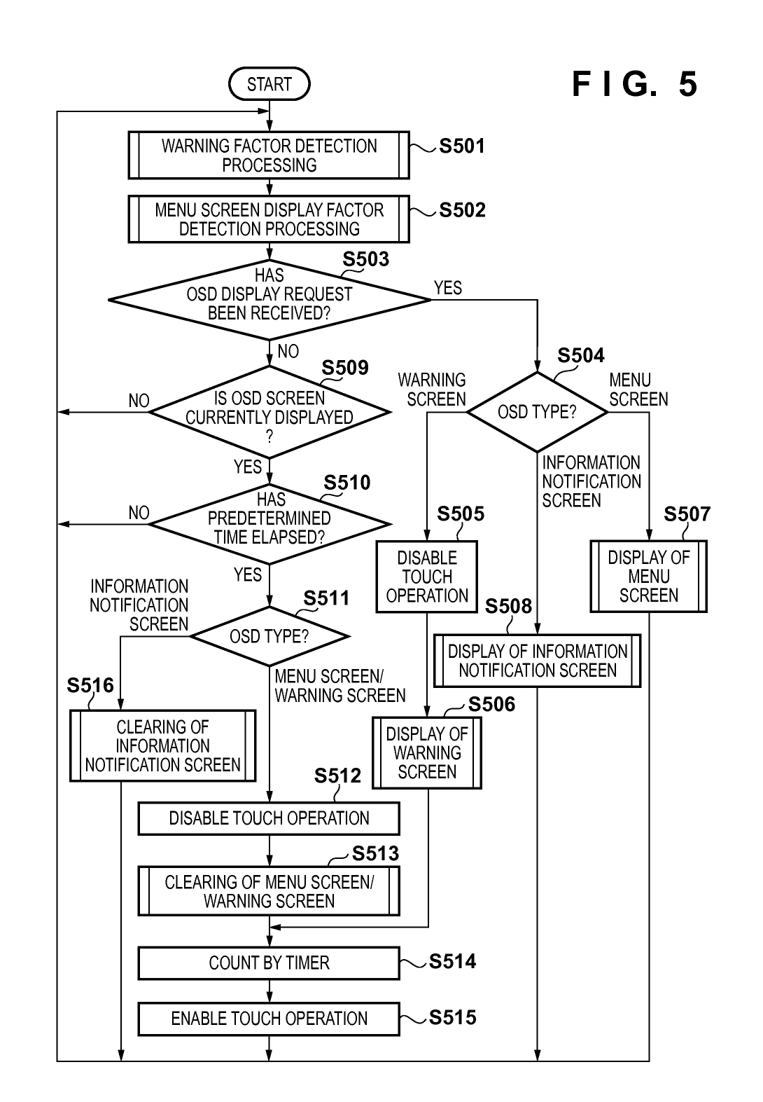

An embodiment will be described with reference to FIGS. 4 and 5, in which the display control apparatus of the present invention is applied to a display device that is connected to a PC, in which an OS supporting a touch panel is installed, and allows the PC or a display unit to be operated through the touch panel.

<Device Configuration>

The configuration and function of a display device according to this embodiment will be schematically described with reference to FIG. 4.

Referring to FIG. 4, a system control unit 401, display screen control unit 402, display screen generation unit 403, timer unit 404, touch operation determination unit 405, touch operation detection unit 406, warning determination unit 407, display control unit 408, display unit 409, touch panel 410, and power button 411 are the same as those shown in FIG. 1.

A menu button 412 is an instruction member for outputting, to the system control unit 401, an operation signal for displaying a menu screen.

A video reception unit 413 includes external output terminals such as an HDMI® terminal, SDI terminal, and composite video terminal, and outputs, to the video reception control unit 414, a video signal output from a PC.

A video reception control unit 414 receives a video signal from the PC via the video reception unit 413.

A video processing unit 415 converts the video signal received by the video reception control unit 414 into the size (resolution) of the display unit 409, and outputs the converted signal to the display control unit 408.

<Basic Operation>

The basic operation of a display device 400 will be explained.

When the user turns on the power button 411, the display device 400 is activated.

When the system control unit 401 detects that the power button 411 is turned on, it outputs a request to receive a video signal from the PC via the video reception unit 413 to the video reception control unit 414, and outputs a request to display the video signal on the display unit 409 to the display control unit 408.

The display control unit 408 converts screen data generated by the display screen generation unit 403 into data to be displayed at a timing appropriate for the display resolution, display color count, and refresh rate of the display unit 409, and outputs the converted data to the display unit 409.

The display unit 409 displays the video signal received via the video reception unit 413, and an information notification screen indicating a video format (resolution, and vertical and horizontal frequencies).

Upon receiving the video signal via the video reception unit 413, the video reception control unit 414 displays the information notification screen indicating the video format (resolution, and vertical and horizontal frequencies) on the display unit 409 in cooperation with the display screen control unit 402, display screen generation unit 403, and display control unit 408.

In this embodiment, when the information notification screen is continuously displayed for a given time (for example, 2 sec), it is cleared. It is impossible to clear the screen by a touch operation by the user.

<Warning Screen Display Processing>

Processing of displaying/clearing a warning screen when the warning determination unit 407 determines whether an event which may influence the function and performance of the display device 400 has occurred will be described by exemplifying a case in which the internal temperature of the device becomes very high.

Processing of displaying a warning screen for notifying that the internal temperature is abnormally high will be explained.

The display device 400 incorporates a temperature sensor (not shown).

The warning determination unit 407 acquires information about the internal temperature of the device, and monitors an increase/decrease in temperature.

When the internal temperature becomes equal to or higher than a predetermined value, or becomes equal to or lower than a predetermined value, the warning determination unit 407 displays an “internal temperature warning screen” on the display unit 409 in cooperation with the display screen control unit 402, display screen generation unit 403, and display control unit 408.

While displaying the warning screen, the display screen control unit 402 starts measuring the display duration of the warning screen in cooperation with the timer unit 404.

FIG. 9B shows a state in which a warning screen 901 for notifying that the internal temperature is abnormally high is displayed while a home screen is displayed.

Processing of clearing the warning screen for notifying that the internal temperature is abnormally high will now be described.

In this embodiment, when the touch operation determination unit 405 determines that the user has tapped an “OK” button on the warning screen, it requests the display screen control unit 402 to clear the warning screen. The display screen control unit 402 clears the internal temperature warning screen displayed on the display unit 409 in cooperation with the display screen generation unit 403 and display control unit 408.

<Menu Screen Display Processing>

Processing of displaying/clearing a menu screen according to this embodiment will be described by exemplifying a case in which the internal temperature warning screen is displayed.

Processing of displaying the menu screen will be explained first.

When the user operates the menu button 412 while the home screen shown in FIG. 6A is displayed, a menu screen (OSD) 601 for operating the display, which is shown in FIG. 6B, is displayed.

When the system control unit 401 detects that the menu button 412 has been operated, it outputs, for example, a request to display the menu screen 601 shown in FIG. 6B to the display screen control unit 402.

Based on the display request received from the display screen control unit 402, the display screen generation unit 403 generates screen data to be displayed on the display unit 409.

The display control unit 408 converts the screen data generated by the display screen generation unit 403 into data to be displayed at a timing appropriate for the display resolution, display color count, and refresh rate of the display unit 409, and outputs the converted data to the display unit 409.

The display unit 409 displays the screen data received from the display control unit 408 on the display panel.

While displaying the menu screen, the display screen control unit 402 starts measuring the display duration of the menu screen in cooperation with the timer unit 404.

The user can set the image quality (mode, brightness, contrast, color temperature, and the like) of the display panel by tapping the menu screen.

Processing of clearing the menu screen will be explained next.

In this embodiment, there are two factors which clear the menu screen. One factor is that the user operates the menu button 412 while the menu screen is displayed. The other factor is that a state in which the user performs no operation continues for a given time (for example, 30 sec) while the menu screen is displayed. When the system control unit 401 detects that the menu button 412 has been operated, it requests the display screen control unit 402 to clear the menu screen. The display screen control unit 402 clears the menu screen displayed on the display unit 409 in cooperation with the display screen generation unit 403 and display control unit 408. Furthermore, the timer unit 404 measures the display duration of the menu screen. When the display screen control unit 402 determines that a state in which the user performs no operation continues for the given time while the menu screen is displayed, it clears the menu screen in cooperation with the timer unit 404.

<Display Control Processing>

Display control processing according to the third embodiment of the present invention will be described with reference to FIG. 5.

In this embodiment, when the warning screen or menu screen is displayed while the user operates the desktop of the display device 400 by the PC, no touch operation is accepted for a predetermined time. More specifically, execution of an operation unintended by the user is suppressed by disabling a touch operation by the user for a given time after the warning screen starts to be displayed and for a given time after the warning screen or menu screen is cleared. The information notification screen, warning screen, and menu screen will be collectively referred to as OSD hereinafter.

Note that processing shown in FIG. 5 starts when the power button 411 of the display device 400 is turned on, and is implemented when the system control unit 401 loads a program stored in a ROM to the work area of a RAM, and executes the program.

In step S501, the warning determination unit 407 acquires information about the internal temperature of the device using the temperature sensor, and determines whether a factor which causes the warning screen for the temperature to be displayed has occurred. If the internal temperature is equal to or higher than a predetermined value or equal to or lower than a predetermined value, the warning determination unit 407 determines that a warning factor has occurred, and requests the display screen control unit 402 to display the “internal temperature warning screen” as a warning screen display request. The display screen control unit 402 displays the “internal temperature warning screen” on the display unit 409 via the display screen generation unit 403 and display control unit 408, and the process advances to step S502.

In step S502, the system control unit 401 determines whether the user has operated the menu button 412. If it is determined that the menu button 412 has been operated, the system control unit 401 requests the display screen control unit 402 to display the menu screen. The display screen control unit 402 displays the “menu screen” on the display unit 409 via the display screen generation unit 403 and display control unit 408, and the process advances to step S503.

In step S503, the display screen control unit 402 determines whether an OSD display request has been received from the video reception control unit 414, warning determination unit 407, or system control unit 401. If it is determined that an OSD display request has been received, the process advances to step S504; otherwise, the process advances to step S509.

In step S504, based on the OSD display request, the display screen control unit 402 determines the type of OSD to be displayed. If it is determined that the OSD type is the warning screen, the display screen control unit 402 requests the touch operation determination unit 405 to disable a touch operation, and the process advances to step S505. If it is determined that the OSD type is the menu screen, the process advances to step S507. If it is determined that the OSD type is the information notification screen, the process advances to step S508.

In step S505, the touch operation determination unit 405 disables a touch operation based on the touch operation disabling request from the display screen control unit 402. A method of disabling a touch operation is the same as that in step S202 or S206 of FIG. 2.

In step S506, the display screen control unit 102 displays the “internal temperature warning screen” on the display unit 409 via the display screen generation unit 403 and display control unit 408, and the process advances to step S514.

In step S507, the display screen control unit 402 displays the “menu screen” on the display unit 409 via the display screen generation unit 403 and display control unit 408, and the process returns to step S501.

In step S508, the display screen control unit 402 displays the “information notification screen” on the display unit 409 via the display screen generation unit 403 and display control unit 408, and the process returns to step S501.

In step S509, the display screen control unit 402 determines whether the OSD screen is currently displayed. If it is determined that the OSD screen is currently displayed, the process advances to step S510; otherwise, the process returns to step S501.

In step S510, the display screen control unit 402 determines whether the display duration of the OSD screen, which is measured by the timer unit 404, is equal to or longer than a predetermined time and the timing of clearing the OSD screen has come. If it is determined that the clearing timing has come, the process advances to step S511; otherwise, the process returns to step S501.

In step S511, the display screen control unit 402 determines the type of the currently displayed OSD screen. If it is determined that the type indicates the menu screen or the warning screen, the display screen control unit 402 requests the touch operation determination unit 405 to disable a touch operation, and the process advances to step S512. If the type indicates the information notification screen, the process advances to step S516.

In step S512, the touch operation determination unit 405 disables a touch operation based on the touch operation disabling request from the display screen control unit 402, similarly to step S505.

In step S513, the display screen control unit 402 is requested to clear the menu screen or warning screen, and then clears the menu screen or warning screen displayed on the display unit 409 in cooperation with the display screen generation unit 403 and display control unit 408.

In step S514, the touch operation determination unit 405 causes the timer unit 404 to measure a time after the warning screen starts to be displayed (step S506) and a time after the menu screen or warning screen is cleared (step S513), and maintains the touch operation disabled state until a predetermined time (for example, 30 sec) elapses.

In step S515, the touch operation determination unit 405 enables a touch operation after the predetermined time elapses. As a method of enabling a touch operation, the touch operation determination unit 405 enables the information obtained from the touch operation detection unit 406 to accept a touch operation by the user.

According to this embodiment, as described above, it is possible to suppress execution of an operation unintended by the user by disabling a touch operation by the user for a given time after the warning screen starts to be displayed and for a given time after the menu screen or warning screen is cleared.

Note that a case in which the display item such as the warning screen, menu screen, or information notification screen is superimposed and displayed on a currently displayed screen has been explained in this embodiment. However, for example, the present invention is also applicable to a case in which a dialog or the like is suddenly displayed on a button or content which the user is about to operate on an application screen, or a case in which an incoming call notification screen is displayed when an incoming call is received while the user is about to operate a content by a tablet terminal or the like.

Furthermore, instead of the method of standing by for a given time after the warning screen or OSD is displayed according to this embodiment, it may be controlled not to display another button or dialog in a touched region during a period from a touch-down operation to a touch-up operation.

Instead of an operation on the touch panel, the present invention is applicable to an operation of a mouse or tablet. More specifically, if a selection operation is executed when the button of the mouse is pressed and then released, it may be controlled not to superimpose and display another button or dialog from when the button of the mouse is pressed until the button is released. Alternatively, it may be controlled not to display another button or dialog from when a pen or finger touches the tablet until the pen or finger is released.

In addition, when one of display items such as various buttons and icons is selected and instructed through the touch panel, the display item may be controlled not to be cleared from when a touch-down operation is performed for the display item until a touch-up operation is performed. This can prevent the user from unintentionally selecting a display item hidden behind the display item.

Even if a factor which displays a dialog or the like occurs during a touch-down operation, it may be controlled to stand by without displaying the dialog or the like during the touch-down operation and to display the dialog or the like after a touch-up operation.

Assume that a touch operation continues for a long time. In this case, if a touch-down operation continues even after standing by for a predetermined time without displaying a dialog or the like, the dialog or the like may be displayed at a position different from the touched position on the touch panel. Note that in this case, if the type of the dialog indicates that the dialog should be displayed at the touched position while no touch-down operation is performed, it is controlled to stand by without displaying the dialog during a touch-down operation. If it is not necessary to display the dialog at the touched position, it may be controlled to display the dialog without standing by.

If a selection operation is executed when the button of the mouse is pressed and then released, it is not necessary to clear the display item from when the button of the mouse is pressed until the button is released. It is not necessary to clear the display item from when a pen or finger touches the tablet until the pen or finger is released.

In the first and second embodiments, the processing shown in FIG. 2 or 3 starts when the tablet terminal is powered on. The present invention, however, is not limited to this. The processing may start immediately after the home screen is displayed, or start in response to a user instruction.

In the first embodiment, a case in which the warning screen for notifying the user of a decrease in remaining battery capacity is displayed has been explained. As in the third embodiment, however, the screen for notifying that the internal temperature is abnormally high or an internal part degrades or fails may be displayed. Instead of the warning screen, a screen for notifying the user of reception of mail or reception of an incoming call may be displayed.

In the first and second embodiments, the time during which a touch operation is disabled is 2 sec. The present invention, however, is not limited to this, 0.5 or 3 sec may be set. The user may arbitrarily change the time.

In the third embodiment, the processing shown in FIG. 5 starts when the display device is powered on. The present invention, however, is not limited to this. The processing may start immediately after the start of reception of a video signal from the outside, or start upon determining that a connected external device can support a touch panel.

Instead of determining whether to display the OSD screen by a button operation, as in the third embodiment, the processing may be executed in response to detection of a touch-down operation (touching the touch panel by a finger or pen) or a touch-up operation (releasing the finger or pen touched on the touch panel).

Furthermore, in the third embodiment, as a time decision method, the time during which a touch operation is disabled may be set according to the type of OSD, or may be arbitrarily changed by the user.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-002661, filed Jan. 9, 2014 which is hereby incorporated by reference herein in its entirety.

What is claimed is:

1. A display control apparatus comprising:
a display control unit configured to superimpose and display a second display item on a first display item on a display unit;
a selection unit configured to select a display item displayed on the display unit; and
a control unit configured to control not to accept a selection operation of the second display item within a predetermined time after the second display item starts to be displayed.

2. The apparatus according to claim 1, wherein for a display item including no instruction member, said control unit controls to accept a selection operation of the display item within the predetermined time after the display item starts to be displayed.

3. The apparatus according to claim 1, wherein said control unit further controls whether to accept a selection operation of a display item within the predetermined time after the display item starts to be displayed in accordance with whether display items are superimposed on each other.

4. The apparatus according to claim 1, wherein said control unit accepts the selection operation of the second display item after the predetermined time elapses.

5. The apparatus according to claim 1, wherein the display item includes an instruction member configured to instruct execution of a predetermined operation when the selection operation is performed by said selection unit.

6. The apparatus according to claim 1, wherein said selection unit is a touch panel provided in the display unit.

7. The apparatus according to claim 1, further comprising a touch operation region decision unit configured to decide, based on a size and a position of one of the first display item and the second display item, a region where the selection operation is not accepted.

8. The apparatus according to claim 1, further comprising a time decision unit configured to decide, based on a type of one of the first display item and the second display item, the predetermined time during which the selection operation is not accepted.

9. A display control apparatus comprising:
a display control unit configured to superimpose and display a second display item on a first display item on a display unit;
a selection unit configured to select a display item displayed on the display unit; and
a control unit configured to control not to accept a selection operation of the first display item within a predetermined time after the second display item which has been superimposed and displayed on the first display item is cleared.

10. The apparatus according to claim 9, wherein for a display item including no instruction member configured to instruct execution of a predetermined operation when the selection operation is performed by said selection unit, said control unit controls to accept a selection operation of the display item within the predetermined time after the display item starts to be displayed.

11. The apparatus according to claim 9, wherein said control unit further controls whether to accept a selection operation of a display item within the predetermined time after the display item starts to be displayed in accordance with whether display items are superimposed on each other.

12. The apparatus according to claim 9, wherein said control unit accepts the selection operation of the first display item after the predetermined time elapses.

13. The apparatus according to claim 9, wherein the display item includes an instruction member for instructing execution of a predetermined operation when the selection operation is performed by said selection unit.

14. The apparatus according to claim 9, wherein said selection unit is a touch panel provided in the display unit.

15. The apparatus according to claim 9, further comprising a touch operation region decision unit configured to decide, based on a size and a position of one of the first display item and the second display item, a region where the selection operation is not accepted.

16. The apparatus according to claim 9, further comprising a time decision unit configured to decide, based on a type of one of the first display item and the second display item, the predetermined time during which the selection operation is not accepted.

17. A display control apparatus comprising:
a display control unit configured to control display contents on a display device; and
an acceptance unit configured to accept an operation of operating a displayed display item,
wherein said display control unit controls not to superimpose and display a second display item on a first display item displayed on the display device during a period in which an operation of the first display item is accepted.

18. The apparatus according to claim 17, wherein a touch panel is provided in the display device, and
the period in which the operation of the first display item is accepted indicates a period from a touch-down operation to a touch-up operation on the touch panel.

19. The apparatus according to claim 18, further comprising a determination unit configured to determine whether a factor which displays the second display item has occurred,
wherein if it is determined that the factor has occurred, said control unit displays the second display item, and
even if it is determined that the factor has occurred, said control unit stands by without displaying the second display item during the touch-down operation, and displays the second display item after the touch-up operation.

20. The apparatus according to claim 19, wherein if the touch-down operation continues even after standing by for a predetermined time without displaying the second display item, said control unit displays the second display item at a position different from a position of the currently touched first display item on the touch panel.

21. The apparatus according to claim 19, wherein the second display item needs to be superimposed and displayed on the currently touched first display item while no touch-down operation is performed, and
if the second display item need not be superimposed and displayed on the first display item, said control unit displays the second display item without standing by even during the touch-down operation.

22. A display control apparatus comprising:
a display control unit configured to control display contents on a display device; and
an acceptance unit configured to accept an operation of operating a displayed display item,
wherein said display control unit controls not to clear a display item displayed on the display device during a period in which an operation of the display item is accepted.

23. The apparatus according to claim 22, wherein a touch panel is provided in the display device, and
the period in which the operation of the display item is accepted indicates a period from a touch-down operation to a touch-up operation on the touch panel.

24. The apparatus according to claim 23, further comprising a determination unit configured to determine whether a factor which displays the display item has occurred,
wherein if it is determined that the factor has occurred, said control unit displays the display item, and
even if it is determined that the factor has occurred, said control unit stands by without displaying the display item during the touch-down operation, and displays the display item after the touch-up operation.

25. The apparatus according to claim 24, wherein if the touch-down operation continues even after standing by for a predetermined time without displaying the display item, said control unit displays the display item at a position different from a currently touched position on the touch panel.

26. The apparatus according to claim 24, wherein the display item needs to be displayed at the currently touched position while no touch-down operation is performed, and
if the display item need not be displayed at the currently touched position, said control unit displays the display item without standing by even during the touch-down operation.

27. A display control method comprising:
a display control step of superimposing and displaying a second display item on a first display item on a display unit;
a selection step of selecting a display item displayed on the display unit; and
a control step of controlling not to accept a selection operation of the second display item within a predetermined time after the second display item starts to be displayed.

28. A display control method comprising:
a display control step of superimposing and displaying a second display item on a first display item on a display unit;
a selection step of selecting a display item displayed on the display unit; and
a control step of controlling not to accept a selection operation of the first display item within a predetermined time after the second display item which has been superimposed and displayed on the first display item is cleared.

29. A display control method comprising:
a display control step of controlling display contents on a display device; and
an acceptance step of accepting an operation of operating a displayed display item,
wherein in the display control step, it is controlled not to superimpose and display a second display item on a first display item displayed on the display device during a period in which an operation of the first display item is accepted.

30. A display control method comprising:
a display control step of controlling display contents on a display device; and
an acceptance step of accepting an operation of operating a displayed display item,
wherein in the display control step, it is controlled not to clear a display item displayed on the display device during a period in which an operation of the display item is accepted.

31. A computer-readable storage medium storing a program for causing a computer to execute the display control method according to claim 27.

32. A computer-readable storage medium storing a program for causing a computer to execute the display control method according to claim 28.

33. A computer-readable storage medium storing a program for causing a computer to execute the display control method according to claim 29.

34. A computer-readable storage medium storing a program for causing a computer to execute the display control method according to claim 30.
